(19) United States
(12) Patent Application Publication
(10) Pub. No.: US 2024/0378445 A1
(43) Pub. Date: Nov. 14, 2024

(54) LEARNING DEVICE, LEARNING METHOD, AND PROGRAM

(71) Applicant: NIPPON TELEGRAPH AND TELEPHONE CORPORATION, Tokyo (JP)

(72) Inventors: Keigo WAKAYAMA, Tokyo (JP); Shoichiro SAITO, Tokyo (JP)

(73) Assignee: NIPPON TELEGRAPH AND TELEPHONE CORPORATION, Tokyo (JP)

(21) Appl. No.: 18/578,279

(22) PCT Filed: Jul. 20, 2021
(86) PCT No.: PCT/JP2021/027113

§ 371 Date: Jan. 10, 2024

(51) Int. Cl. G06N 3/0895; G06N 3/0464

(52) U.S. Cl. CPC G06N 3/0895; G06N 3/0464

(57) ABSTRACT

A learning device includes a learning unit that acquires learning data including data and a correct answer label assigned to the data and learns a weight of a DNN model for predicting an acoustic event from the learning data, the DNN model including: a feature extraction layer in which layers from an input layer to a predetermined intermediate layer have a structure similar to a structure of layers from an input layer to an intermediate layer of a CNN, and layers from the predetermined intermediate layer to an output layer have a structure similar to a structure of layers from an intermediate layer to an output layer of a SAN; and a prediction layer that predicts an event from an output of the feature extraction layer.

### TECHNICAL FIELD

The present invention relates to a learning device, a learning method, and a program for learning a model used for acoustic event detection.

### BACKGROUND ART

Non Patent Literature 1 discloses a conventional technique of acoustic event detection based on weakly supervised learning. Non Patent Literature 2 discloses a conventional technique of image recognition based on Self-attention Networks (SAN).

### CITATION LIST

### Non Patent Literature

Non Patent Literature 1: Q. Kong et al., “Sound event detection of weakly labelled data with CNN-transformer and automatic threshold optimization”, IEEE/ACM TASLP (28), 2020, pp. 2450-2460.

Non Patent Literature 2: H. Zhao et al., “Exploring Self-Attention for Image Recognition”, CVPR, 2020, pp. 10076-10085.

### SUMMARY OF INVENTION

### Technical Problem

In order to improve the prediction accuracy of acoustic event detection or to increase the number of classifiable classes, a mechanism for efficiently using various types of data is required. Specifically, improvement of generalization performance by advancement of a DNN architecture and the like can be considered. In Non Patent Literature 1, a CNN-Transformer, which combines a CNN as a standard in the image field and a Transformer having overwhelming performance in the language field, is used as a DNN architecture for weakly supervised acoustic event detection. In the CNN-Transformer, a time-frequency representation of an acoustic signal is regarded as image data, high-level features are extracted and then aggregated in the frequency bin direction, the aggregated features are regarded as a time-series signal, a dependence relationship in the time direction is captured, and an existence probability of an event in the time direction is expressed by the transformed/interpolated features. Existing architectures mostly use CNNs with low parameter efficiency, it is difficult to efficiently express data of acoustic event detection, and there is a limit to a prediction accuracy that can be achieved and the number of classes that can be classified. Therefore, a new DNN architecture having higher generalization performance than the CNN-Transformer is required.

Furthermore, in the field of image recognition, Non Patent Literature 2 proposes replacing a CNN, which is a standard in the image field, with a Self-attention Network (SAN) having high parameter efficiency. The CNN can adapt only to the channel direction, and Scalar attention (Transformer etc.) can adapt only to the spatial direction, but the SAN, which is Vector attention, can adapt to both the channel direction and the spatial direction, so that a model with high parameter efficiency can be constructed. In a preliminary study, it has been found that it is difficult to construct a model having higher generalization performance than that of the CNN-Transformer only by replacing the CNN of the CNN-Transformer used in Non Patent Literature 1 with the SAN. It is assumed that this is because the properties of the data differ between the image data and the time-frequency representation of the acoustic signal. Therefore, it is necessary to construct a model having high generalization performance with the properties of the acoustic signal grasped well.

Therefore, an object of the present invention is to provide a learning device capable of constructing a new DNN model with high generalization performance.

### Solution to Problem

A learning device of the present invention includes a learning unit. The learning unit acquires learning data including data and a correct answer label assigned to the data and learns a weight of a DNN model for predicting an acoustic event from the learning data. The DNN model includes: a feature extraction layer in which layers from an input layer to a predetermined intermediate layer have a structure similar to a structure of layers from an input layer to an intermediate layer of a CNN, and layers from the predetermined intermediate layer to an output layer have a structure similar to a structure of layers from an intermediate layer to an output layer of a SAN; and a prediction layer that predicts an event from an output of the feature extraction layer.

### Advantageous Effects of Invention

According to a learning device of the present invention, it is possible to construct a new DNN model having high generalization performance.

### BRIEF DESCRIPTION OF DRAWINGS

FIG. 1 is a diagram illustrating a comparison between conventional models and a model learned by a learning device of Example 1.

FIG. 2 is a block diagram illustrating a functional configuration of the learning device of Example 1.

FIG. 3 is a flowchart illustrating an operation of a learning unit of the learning device of Example 1.

FIG. 4 is a flowchart illustrating an operation of an estimation unit of the learning device of Example 1.

FIG. 5 is a diagram illustrating experimental results of acoustic tagging and acoustic event detection by conventional methods and a method of Example 1.

FIG. 6 is a diagram illustrating a functional configuration example of a computer.

### DESCRIPTION OF EMBODIMENTS

Hereinafter, an embodiment of the present invention will be described in detail. Note that components having the same functions will be denoted by the same reference signs, and redundant description will be omitted.

### Example 1

A learning device of following Example 1 is a device related to acoustic event detection, and is characterized in that shallow intermediate layers are configured with a CNN and deep (other) intermediate layers and an output layer are configured with a SAN, in order to avoid a state like over-fitting in a conventional technique in which a CNN is replaced with a SAN while expressing acoustic features that cannot be expressed by a CNN in a conventional technique in which the CNN and a transformer are combined.

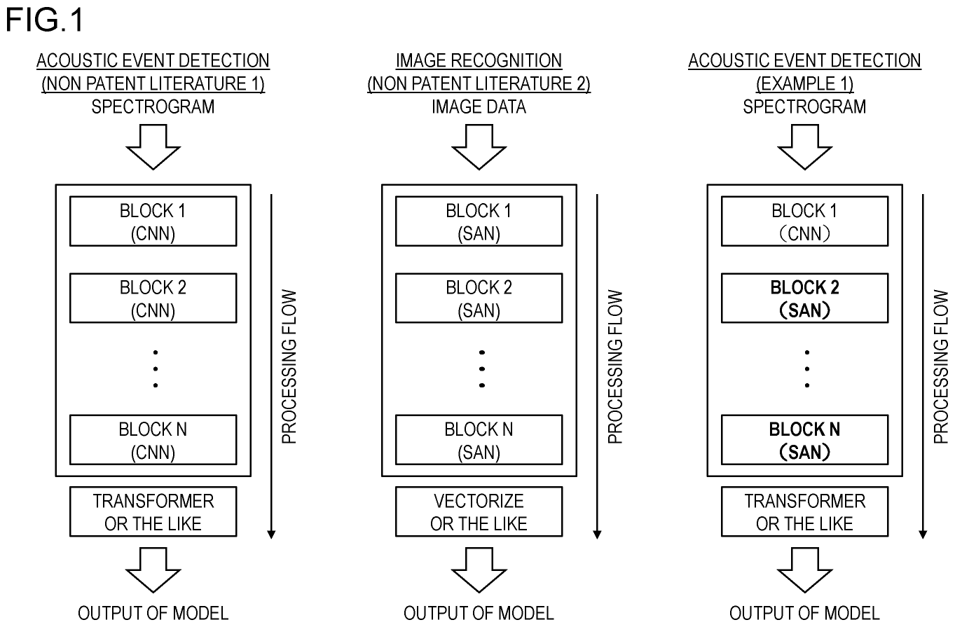

As illustrated in FIG. 1, in a DNN model learned by the learning device of Example 1, layers from an input layer to a predetermined intermediate layer (two layers of a block 1 in the example of FIG. 1) of a feature extraction layer have a structure similar to that of layers from an input layer to an intermediate layer of the CNN, layers from the predetermined intermediate layer to an output layer (a block 2 to a block N in the example of FIG. 1) have a structure similar to that of layers from the intermediate layer to an output layer of the SAN, and a prediction layer (Transformer) that predicts an event from an output of the feature extraction layer is included. As a result, it is possible to implement a DNN model by a new DNN architecture (CNN-SAN-Transformer) in which all remaining layers (for example, in the case of N=4, six layers of three blocks of block 2 to block 4) occupying most of the number of parameters are replaced with the SAN with high parameter efficiency in order to acquire an intermediate representation independent of properties of data from low-level features specific to an acoustic signal and efficiently extract high-level features from the intermediate representation with a higher abstraction level than the data. As a result, the SAN with high parameter efficiency can be incorporated into the model, and a prediction accuracy equal to or higher than that of the CNN-Transformer can be achieved with a small number of parameters.

### <Learning Device 1>

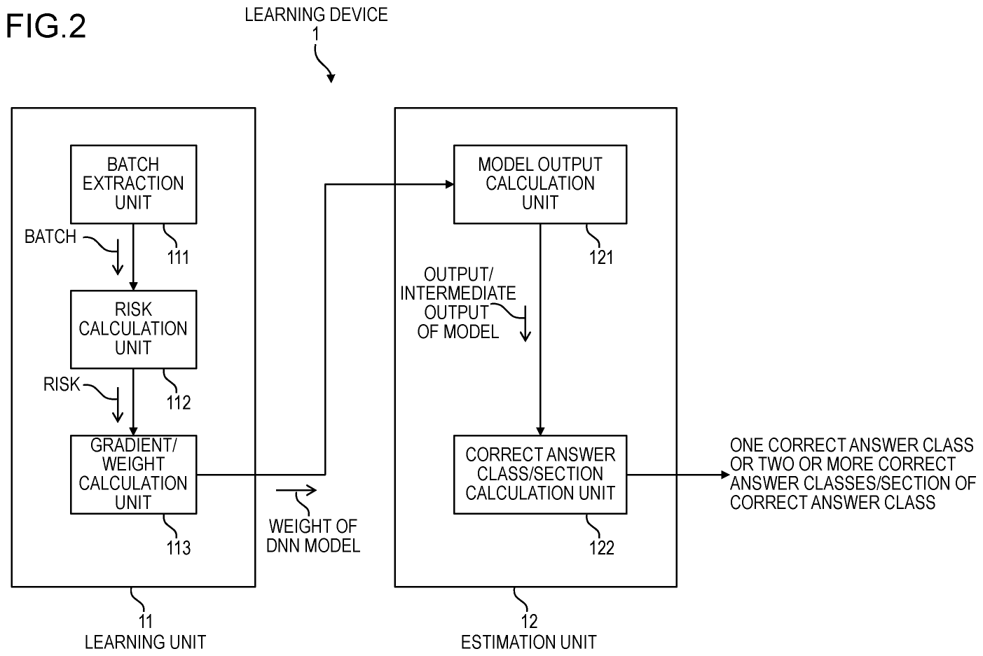

Hereinafter, a functional configuration of a learning device 1 of the present example will be described with reference to FIG. 2. As illustrated in FIG. 2, the learning device 1 of the present example includes a learning unit 11 and an estimation unit 12.

### <Learning Unit 11>

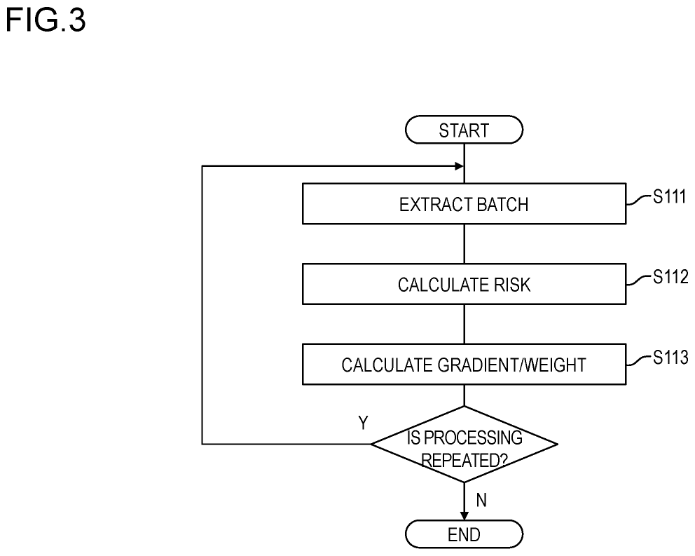

The learning unit 11 acquires learning data including data (time-frequency representation of an acoustic signal, that is, spectrogram) and a correct answer label (one class or two or more classes) assigned to the data, and learns a weight of a DNN model (CNN-SAN-Transformer described above) for predicting an acoustic event from the learning data so as to minimize a classification risk in correct answer label learning. More specifically, the learning unit 11 includes a batch extraction unit 111, a risk calculation unit 112, and a gradient/weight calculation unit 113, and these components execute the following operations (see FIG. 3).

### <<Batch Extraction Unit 111>>

The batch extraction unit 111 extracts a part of the learning data as a batch (S111).

### <<Risk Calculation Unit 112>>

The risk calculation unit acquires the batch and calculates a risk in correct answer label learning for the purpose of multi-label classification by use of the DNN model (CNN-SAN-Transformer) and a Binary Cross Entropy loss function (S112).

<<Gradient/Weight Calculation Unit 113>>

The gradient/weight calculation unit 113 acquires the risk and updates the weight of the DNN model (CNN-SAN-Transformer) so as to minimize the classification risk in the correct answer label learning (S113). The operations of the batch extraction unit 111, the risk calculation unit 112, and the gradient/weight calculation unit 113 (steps S111, S112, and S113) are repeatedly executed, and finally, the (learned) weight of the DNN model (CNN-SAN-Transformer) is acquired.

### <Estimation Unit 12>

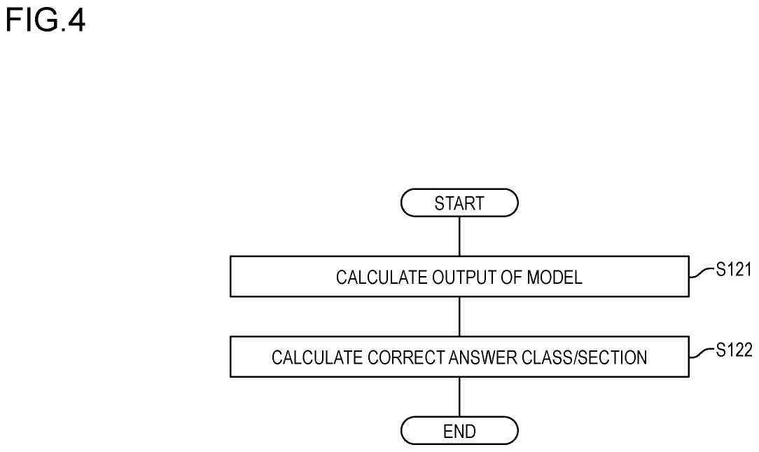

The estimation unit 12 acquires new data used for class estimation and the learned weight of the DNN model (CNN-SAN-Transformer), and estimates one correct answer class or two or more correct answer classes and a section in which the correct answer class is present. More specifically, the estimation unit 12 includes a model output calculation unit 121 and a correct answer class/section calculation unit 122, and the components execute the following operations (see FIG. 4).

### <<Model Output Calculation Unit 121>>

The model output calculation unit 121 calculates an output and an intermediate output of the DNN model (CNN-SAN-Transformer) (S121).

### <<Correct Answer Class/Section Calculation Unit 122>>

The correct answer class/section calculation unit 122 acquires the output and the intermediate output of the DNN model (CNN-SAN-Transformer), and calculates one correct answer class or two or more correct answer classes and a section in which the correct answer class is present (S122).

### <<About SAN>>

Although the SAN is used in the above-described example, this can be replaced with an attention mechanism (including mechanisms other than self-attention and multi head).

### <<About CNN>>

Although the CNN is used in the above-described example, the CNN can be replaced with a convolutional NN.

### <<Experimental Results of Acoustic Tagging and Acoustic Event Detection by Conventional Methods and Method of Present Example>>

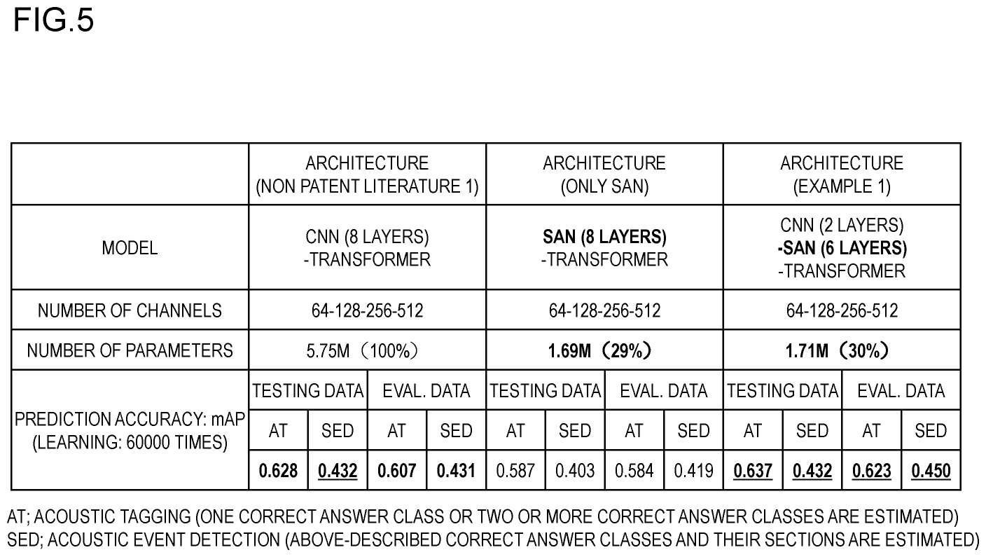

FIG. 5 illustrates experimental results of acoustic tagging and acoustic event detection by conventional methods and the method of the present example. As illustrated in FIG. 5, according to the DNN model learned by the method of the present example, a prediction accuracy equal to or higher than those of the conventional techniques was achieved in both acoustic tagging and acoustic event detection. Note that the reason why the CNN is arranged at the head of the feature extraction layer in the DNN architecture of the present example is because the features were successfully extracted for the low dimension of the data of acoustic signals.

### <Supplement>

A device of the present invention as a single hardware entity includes, for example, an input unit to which a keyboard or the like can be connected, an output unit to which a liquid crystal display or the like can be connected, a communication unit to which a communication device (for example, a communication cable) capable of communicating with the outside of the hardware entity can be connected, a central processing unit (CPU in which a cache memory, a register, or the like may be included), a RAM or a ROM as a memory, an external storage device as a hard disk, and a bus that connects the input unit, the output unit, the communication unit, the CPU, the RAM, the ROM, and the external storage device such that data can be exchanged therebetween. Moreover, a device (drive) or the like that can read and write data from and to a recording medium such as a CD-ROM may be provided in the hardware entity as necessary. Examples of a physical entity including such hardware resources include a general-purpose computer.

The external storage device of the hardware entity stores programs required for implementing the above-described functions, data required for processing of the programs, and the like (the programs may be stored, for example, in the ROM as a read-only storage device instead of the external storage device). Furthermore, data or the like obtained by the processing of the programs is appropriately stored in the RAM, the external storage device, or the like.

In the hardware entity, the programs stored in the external storage device (or the ROM or the like) and data required for the processing of the programs are read into a memory as necessary and are appropriately interpreted and processed by the CPU. As a result, the CPU implements a predetermined function (each component represented as unit, . . . means, or the like).

The present invention is not limited to the above-described embodiment and can be appropriately modified without departing from the gist of the present invention. Furthermore, the processing described in the above embodiment may be executed not only in chronological order according to the described order, but also in parallel or individually according to the processing capability of the device that executes the processing or as necessary.

As described above, in a case where the processing functions of the hardware entity (the device of the present invention) described in the above-described embodiment are implemented by a computer, processing contents of the functions of the hardware entity are described by a program. In addition, the computer executes the program, and thus, the processing functions of the hardware entity are implemented on the computer.

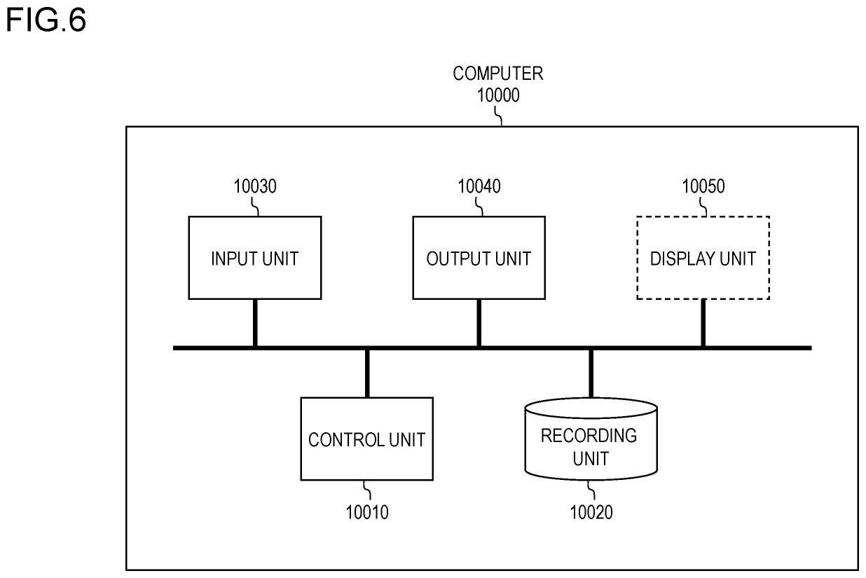

Various types of processing described above can be carried out by causing a recording unit 10020 of a computer 10000 illustrated in FIG. 6 to read the program for executing each step of the method described above and causing a control unit 10010, an input unit 10030, an output unit 10040, and the like to operate.

The program describing the processing contents may be recorded on a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

Furthermore, the program is distributed by, for example, selling, transferring, or renting a portable recording medium such as a DVD or a CD-ROM in which the program is recorded. Furthermore, a configuration may also be employed in which the program is stored in a storage device of a server computer and the program is distributed by being transferred from the server computer to another computer via a network.

For example, the computer that executes such a program first temporarily stores the program recorded in the portable recording medium or the program transferred from the server computer in its own storage device. At the time of execution of processing, the computer then reads the program stored in its own recording medium, and executes the processing according to the read program. As another mode of executing the program, the computer may directly read the program from the portable recording medium and execute the processing according to the program, or, every time the program is transferred from the server computer to the computer, the computer may sequentially execute the processing according to the received program. In addition, the above-described processing may be executed by a so-called application service provider (ASP) type service, which implements a processing function only by an execution instruction and result acquisition without transferring the program from the server computer to the computer. Note that the program in this mode includes information used for processing by an electronic computer and equivalent to the program (data or the like that is not a direct command to the computer but has a property for defining processing of the computer).

In addition, although the hardware entity is configured by a predetermined program being executed on a computer in this mode, at least some of the processing contents may be implemented by hardware.

1. A learning device comprising:
processing circuitry configured to
acquire learning data including data and a correct answer label assigned to the data and learn a weight of a DNN model for predicting an acoustic event from the learning data,
the DNN model including: a feature extraction layer in which layers from an input layer to a predetermined intermediate layer have a structure similar to a structure of layers from an input layer to an intermediate layer of a CNN, and layers from the predetermined intermediate layer to an output layer have a structure similar to a structure of layers from an intermediate layer to an output layer of a SAN; and a prediction layer that predicts an event from an output of the feature extraction layer.

2. The learning device according to claim 1, comprising:
processing circuitry configured to
extract a part of the learning data as a batch;
acquire the batch and calculate a risk in correct answer label learning for a purpose of multi-label classification by use of the DNN model and a Binary Cross Entropy loss function; and
acquire the risk and update the weight of the DNN model so as to minimize the risk.

3. A learning method executed by a learning device, the learning method comprising
a learning step of acquiring learning data including data and a correct answer label assigned to the data and learning a weight of a DNN model for predicting an acoustic event from the learning data,
the DNN model including: a feature extraction layer in which layers from an input layer to a predetermined intermediate layer have a structure similar to a structure of layers from an input layer to an intermediate layer of a CNN, and layers from the predetermined intermediate layer to an output layer have a structure similar to a structure of layers from an intermediate layer to an output layer of a SAN; and a prediction layer that predicts an event from an output of the feature extraction layer.

4. A program for causing a computer to function as the learning device according to claim 1.

5. A program for causing a computer to function as the learning device according to claim 2.
